(19) United States
(12) Patent Application Publication
(10) Pub. No.: US 2004/0236806 A1
(43) Pub. Date: Nov. 25, 2004

(54) Method, apparatus and articles of manufacture for computing the sensitivity partial derivatives of linked mechanical systems

(76) Inventor: James D. Turner, Iowa City, IA (US)

Correspondence Address: Schwegman, Lundberg, Woessner & Kluth, P.A., P.O. Box 2938, Minneapolis, MN, 55402, US

(21) Appl. No.: 10/609,327

(22) Filed: Jun. 24, 2003

Related U.S. Application Data
(60) Provisional application No. 60/391,357, filed on Jun. 24, 2002.

(51) Int. Cl. G06J 1/00; G06F 7/38; G06G 7/18

(52) U.S. Cl. 708/6; 708/443; 708/822

(57) ABSTRACT

A chain rule-based evaluation technique is presented for analytically evaluating partial derivatives of nonlinear functions or differential equations defined by a high-level language. A coordinate embedding strategy is introduced that replaces all scalar variables with higher-dimensional objects. The higher dimensional objects are defined by a concatenation of the original scalar and its Jacobian and Hessian partials. The artificial problem dimensions permit exact sensitivity models to be recovered for arbitrarily complex matrix-vector models. An object-oriented operator-overloading technique is used to provide a familiar conceptual framework for generating the model sensitivity data. First- and second-order partial derivative models are automatically evaluated by defining generalized operators for multiplication, division, and composite function calculations. The new algorithm replaces a normally complex, error-prone, time-consuming, and labor-intensive process for producing the partials with an automatic procedure, where the user is completely hidden from the details. The algorithm supports both numerical and symbolic model generation. Module functions are used to encapsulate new data types, and extended math and library functions for handling vector, tensor, and embedded variables. Current capabilities support math models for scalar, vector, linear matrix equations, and matrix inversion. The algorithm has broad potential for impacting the design and use of mathematical programming tools for applications in science and engineering. Several applications for presented demonstrating the effectiveness of the methods.

This application claims priority under 35 U.S.C. 119(e) to U.S. Provisional Application Ser. No. 60/391,357, filed Jun. 24, 2002, and entitled “The Application of Clifford Algebras for Computing the Sensitivity Partial Derivatives of Linked Mechanical Systems”, the entire disclosure of which is hereby incorporated herein by reference.

### BACKGROUND OF THE INVENTION

The calculation of sensitivity partial derivatives is a frequently occurring task during the engineering design and control process. Sensitivity models are derived from an underlying math model of the physical system. Traditionally there have been two approaches for developing the sensitivity partial derivatives: (i) analytical models, and (ii) numerical models using finite difference-like techniques. Analytical models are preferred when available, though the additional modeling, software development, and checkout are often time-consuming and expensive. Numerical methods are conceptually straightforward, however, many methods must sample a function two or more times to estimate the sensitivity.

### BRIEF DESCRIPTION OF THE DRAWING

FIG. 1 illustrates a plot of relative growth rates of polynomials according to one example embodiment of the invention.

FIG. 2 illustrates an example FOTRAN subroutine according to one example embodiment of the invention.

FIG. 3 illustrates an example computer platform with an Object-Oriented Cartesian Embedding Algorithm (OCEA) according to one example embodiment of the invention.

### DETAILED DESCRIPTION OF THE INVENTION

I. Introduction

The present invention presents a third alternative approach for generating the sensitivity data: An Object-Oriented Cartesian Embedding Algorithm (OCEA). The computational advantage of the OCEA approach is that a single function evaluation yields the function value and the associated Jacobian and Hessian partial derivatives. The user is completely hidden from the details of how the partial derivatives are generated. The algorithm has been implemented in Fortran 90 and Macsyma 2.4. Module functions (Fortran 90/95) are used to encapsulate new data types, and extended math and library functions for handling vector, tensor, and embedded variables. According to certain example embodiments, the present invention supports math models for scalar, vector, linear matrix equations, and matrix inversion.

OCEA is a chain rule-based evaluation technique for analytically evaluating partial derivatives with respect to input variables of functions defined by a high-level language [Turner, 2002]. All of the problem functions are assumed to have continuous partial derivatives through second-order. Operationally, OCEA replaces conventional computer algebra operations and functions with generalized OCEA versions of these capabilities. The use of operator-overloading techniques permits a familiar conceptual framework to surround the use of OCEA software. The operator-overloading techniques redefine the intrinsic mathematical binary operators {+, −, *, **, /} and unary functions {cos(x), sin(x), tan(x), log(x), . . . }. New derived data types, interface operators, and generalized mathematical operators are developed for computing the first and second order partials.

Automatic differentiation has existed as a research topic since the 1980's. The common idea has been to pre-process a programmed function, identify the unary and binary functional operations, and build up forward and backward computational strategies. A successful implementation of this approach is ADIFOR (Automatic Differentiation of FORtran), which transforms the model source code based on a specification of dependent and independent variables, and produces source code that calculates the derivatives of the dependent variables with respect to the independent variables [Griewank, 89; Bischof, Carle, Corliss, Griewank, and Hovland, 92; Bisehof, Carle, Khademi, Mauer, and Hovland, 95; Eberhard and Bischof, 96; Hovland and Heath 97]. Other related codes include ADOI [Pryce and Reid, 98] which handles higher order derivatives using the chain rule and computational graphs. OCEA, unlike these previously developed tools, has the capability to build models on the fly, exploit high order models, and provide simple extensions for handling matrix calculations. No distinction is made between the independent and dependent variables. OCEA operates at the elementary scalar level, regardless of the complexity of the mathematical object.

Mathematically, OCEA replaces each scalar operation with a higher dimension object. For example, assuming the g is a 1×1 scalar in traditional computer algebra, and introducing the OCEA-based transformation process, one obtains:

$$\begin{matrix}g := [ \begin{matrix}g , & {∇}^{->} g , & {∇}^{->} {∇}^{->} g\end{matrix} ] ; & {∇}^{->} = {\hat{n}}_{1} \frac{\partial }{\partial {x}_{1}} + ⋯ + {\hat{n}}_{m} \frac{\partial }{\partial {x}_{m}} \\ \underbrace{}_{1 \times 1} \underbrace{}_{m \times 1} \underbrace{}_{m \times m} & \end{matrix} \qquad ( 1 )$$

where xᵢ(i=1, . . . , m) denotes the vector of independent variables, \hat{n}ᵢ, =(δᵢ₁, . . . δᵢₘ) denotes a unit vector in the i-th coordinate direction, and the transformed version of g is now of dimension 1×(1+m+m²). Generalizations for higher dimensional versions of OCEA are obvious. Because of the rapid increase in the number of partial derivatives as the order of the OCEA method increases, it becomes critically important to exploit symmetry. As a point of comparison, if a q-th order version of OCEA is considered, the dimension of each transformed OCEA scalar becomes

$${\sum }_{n = 0}^{q} {m}^{n} = ( 1 - {n}^{q + 1} ) / ( 1 - m )$$

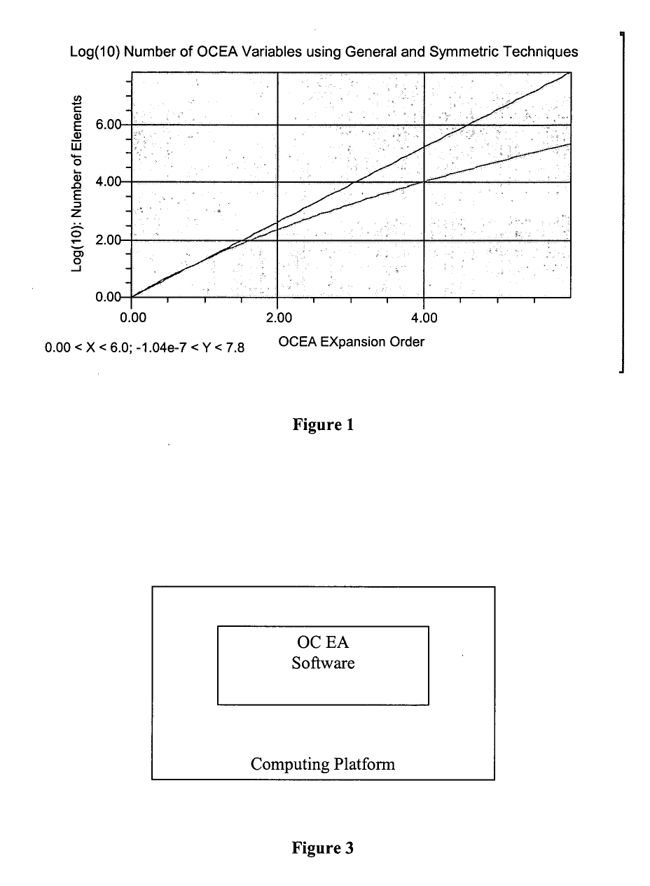

when symmetry is not exploited. If symmetry is exploited the dimension of each transformed OCEA scalar becomes

$${\sum }_{n = 0}^{q} ( \begin{matrix}n + m - 1 \\ m - 1\end{matrix} ) = ( \begin{matrix}q + m \\ m\end{matrix} )$$

where (*) denotes the binomial coefficient. A plot of the relative growth rates is presented in FIG. 1.

A benefit of the OCEA operator overloading strategy is that standard programming language constructs are used in building mathematical models. The complier recognizes that new data types and automatically replaces the conventional intrinsic operators and functions with generalized OCEA intrinsic operators and functions. For example, imagine that one wants to evaluate f=xy/\sqrt{z} using standard Fortran and OCEA-enhanced Fortran, as shown in Table 1:

TABLE 1
Comparison of Fortran and OCEA Fortran Models

| Math Model | $f = xy / \sqrt{z}$ |
|---|---|
| Fortran | f = x * y/sqrt(z) |
| f := (scalar) | |
| OCEA-Enhanced Fortran F := (scalar, vector, tensor) | $\begin{matrix}f = x * y / sqrt ( z ) \\ = [ \begin{matrix}f , \\ [ \begin{matrix}\frac{\partial f}{\partial x} & \frac{\partial f}{\partial y} & \frac{\partial f}{\partial z}\end{matrix} ] , \\ [ \begin{matrix}\frac{{\partial }^{2} f}{\partial x \partial x} & \frac{{\partial }^{2} f}{\partial x \partial y} & ⋯ & \frac{{\partial }^{2} f}{\partial z \partial z}\end{matrix} ]\end{matrix} ]\end{matrix}$ |

where three independent OCEA variables are defined (namely, x, y, z) and the Fortran and OCEA-Enhanced Fortran models are seen to be identical. The OCEA calculations, however, are very different from the Fortran calculations. The analyst never formulates or codes the partial derivatives. OCEA represents a linearized Clifford algebra.

This patent includes seven sections. Section 2 presents the mathematical foundation for OCEA. Section 3 presents the software operator overloading, data typing, interface operators, and generalized transformational operators for multiplication, division, and composite function evaluations. A differential equation sensitivity approach is presented in Section 4. A simple example is worked out in detail to highlight the operational steps required for using OCEA methodology in Section 5. Several non-trivial applications are presented in Section 6 for handling nonlinear vector functions, equation of motion generation using Lagrange's equations, and differential equations. Applications are presented in Section 7.

II. Mathematical Formulation

The mathematical models for the OCEA are presented in this section. An essential step in the algorithm is that the independent coordinates are transformed using Eq. (1), leading to:

$$\begin{matrix} {x}_{i} := [ \begin{matrix}{x}_{i} , & [ \begin{matrix}{δ}_{1 i} \\ ⋮ \\ {δ}_{ni}\end{matrix} ] , & [ \begin{matrix}0 & ⋯ & 0 \\ ⋮ & ⋰ & ⋮ \\ 0 & ⋯ & 0\end{matrix} ]\end{matrix} ] \\ 1 \times 1 \; 1 \times 1 n \times 1 n \times n \\ \underbrace{}_{1 \times ( 1 + n + {n}^{2} )}\end{matrix}$$

where δᵢⱼ denotes the standard kronecker delta function and i=1, . . . , n. The independent variables initialize the calculations for the embedded variables.

II.1 Intrinsic Operators and Functions

The generalizations for the intrinsic mathematical operators and functions are presented for addition, subtraction, multiplication, division, and composite functions. Addition and subtraction are straightforward. The most challenging generalizations are required for the product, division, and composite function calculations. All of the following transform equations assume that Jacobian and Hessian data for g and h has been built up from previous computational operations. One should observe that the tensor parts of the operators above frequently require vector outer products to complete the mathematical models. Many opportunities exist for exploiting the sparse structure of the resulting vector and tensor operations. The embedded coordinate mathematical operators follow as:

$$\begin{matrix}Addition \text{:} & & \\ & & g + h = [ g , {∇}^{->} g , {∇}^{->} {∇}^{->} g ] + [ h , {∇}^{->} h , {∇}^{->} {∇}^{->} h ] \\ & & = [ g + h , {∇}^{->} g + {∇}^{->} h , {∇}^{->} {∇}^{->} g + {∇}^{->} {∇}^{->} h ] \\ Subtraction \text{:} & & \\ & & g - h = [ g , {∇}^{->} g , {∇}^{->} {∇}^{->} g ] - [ h , {∇}^{->} h , {∇}^{->} {∇}^{->} h ] \\ & & = [ g - h , {∇}^{->} g - {∇}^{->} h , {∇}^{->} {∇}^{->} g - {∇}^{->} {∇}^{->} h ]\end{matrix}$$

Product Rule:

$$\begin{matrix}g * h := [ g , {∇}^{->} g , {∇}^{->} {∇}^{->} g ] * [ h , {∇}^{->} h , {∇}^{->} {∇}^{->} h ] \\ = [ g * h , g * {∇}^{->} h + h * {∇}^{->} g , \\ g * {∇}^{->} {∇}^{->} h + {∇}^{->} {g ( {∇}^{->} h )}^{T} + {∇}^{->} {h ( {∇}^{->} g )}^{T} + h * {∇}^{->} {∇}^{->} g ]\end{matrix}$$

Division Rule:

$$\begin{matrix}g / h := [ g , {∇}^{->} g , {∇}^{->} {∇}^{->} g ] / [ h , {∇}^{->} h , {∇}^{->} {∇}^{->} h ] \\ = [ \begin{matrix}g / h , \\ ( \frac{h {∇}^{->} g - g {∇}^{->} h}{{h}^{2}} ) , \\ ( \frac{h {∇}^{->} {∇ g}^{->} - g {∇}^{->} {∇}^{->} h - {∇}^{->} {g ( {∇}^{->} h )}^{T} - {∇}^{->} {h ( {∇}^{->} g )}^{T}}{{h}^{2}} ) + \\ ( \frac{2 * g {∇}^{->} {h ( {∇}^{->} h )}^{T}}{{h}^{3}} )\end{matrix} ]\end{matrix}$$

Composite Function Rule:

$$f ( [ g , {∇}^{->} g , {∇}^{->} {∇}^{->} g ] ) := [ f ( g ) , \frac{\partial f}{\partial g} {∇}^{->} g , \frac{{\partial }^{2} f}{\partial {g}^{2}} {∇}^{->} {g ( {∇}^{->} g )}^{T} + \frac{\partial f}{\partial g} {∇}^{->} {∇}^{->} g ]$$

where the three scalar values for f(g), ∂f/∂g, and ∂²f/∂g² are computed using standard intrinsic mathematical functions.

II.2 Example Embedded Function Calculations

This section considers the calculation of embedded versions of \sqrt{g} and tan⁻¹(g). The square root calculation is considered first.

II.2.1 \sqrt{g} Calculation: Referring to the composite function rule above one has f(g)=\sqrt{g} which leads to

$$\frac{\partial f}{\partial g} = \frac{1}{\sqrt{g}} , and \frac{{\partial }^{2} f}{\partial {g}^{2}} = \frac{- 1}{2 * {g}^{3 / 2}} ,$$

so that the embedded composite square root function is given by:

$$\sqrt{g} := \sqrt{[ g , {∇}^{->} g , {∇}^{->} {∇}^{->} g ]} = [ \sqrt{g} , \frac{{∇}^{->} g}{\sqrt{g}} , \frac{- {∇}^{->} {g ( {∇}^{->} g )}^{T}}{2 * {g}^{3 / 2}} + \frac{{∇}^{->} {∇}^{->} g}{\sqrt{g}} ]$$

The tan⁻¹(g) calculation is considered next.

II.2.2 tan⁻¹(g) Calculation: Referring to the composite function rule above one has f(g)=tan⁻¹(g), which leads to

$$\frac{\partial f}{\partial g} = \frac{1}{1 + {g}^{2}} , \text{and} \frac{{\partial }^{2} f}{\partial {g}^{2}} = \frac{- 2 g}{{( 1 + {g}^{2} )}^{2}} ,$$

so that the embedded composite tan⁻¹(g) function is given by:

$${tan}^{- 1} ( g ) := {tan}^{- 1} ( [ g , \vec{∇} g , \vec{∇} \vec{∇} g ] ) = [ {tan}^{- 1} ( g ) , \frac{\vec{∇} g}{1 + {g}^{2}} , \frac{- 2 g \vec{∇} {g ( \vec{∇} g )}^{T}}{{( 1 + {g}^{2} )}^{2}} + \frac{\vec{∇} \vec{∇} g}{1 + {g}^{2}} ]$$

Similar generalizations have been developed for the operators “**”, sin, cos, tan, asin, acos, exp, log, sinh, cosh, and tanh. Others can be easily developed as required.

III. Software Architecture

According to one example embodiment, the OCEA mathematical operators and functions are translated into an object-oriented language where operator-overloading techniques are employed to re-define the algebraic operations that control the computational procedures. According to one embodiment, A Fortran 90 version of OCEA may be provided. An OCEA program is shown executing on a suitable computing platform, such as a personal computer or workstation, or other computing system, in FIG. 3, wherein the software is stored in a machine readable form in memory, on a magnetic or optical disk, or in the form of a digital signal in electrical form. Defined data types, interface operator definitions, and module functions are used for encapsulating the data types and providing a language extension that supports the automatic generation of partial derivatives. As shown in Section II, according to one example embodiment, three derived data types are required: vector, tensor, and embedded. The embedded capabilities provide the OCEA capabilities for libraries of mathematical operators and functions. The introduction of derived data types provides a software advantage; namely, that the compiler can detect the data types involved in a calculation and invoke the correct subroutine or function without user intervention. This is achieved in the software architecture design by providing typed data subroutines and functions for covering all possible mathematical operations. (i.e., real and embedded, embedded and embedded, and so on). For example, Table 2 provides a partial list of the capabilities required for generalizing the assignment (=) and math operators. An additional advantage is that the compiler can use array-processing techniques for handling large problems.

TABLE 2
Operator Overloading for Data Type Operations

| Data Types (A&B) | Operations | Math Model |
|---|---|---|
| Embedded, Embedded | “+”, ”−“, ”=” | A + B, A − B |
| Embedded, Vector | “=” | A = B |
| Vector, Embedded | “=” | A = B |
| Vector, Scalar | “*”, ”=” | A = b*A, Aᵢ = b, i = 1, . . ., n |
| Tensor, Tensor | “=” | A = B |
| Embedded, Embedded | “sin” | A = sin(B) |

Two detailed examples are provided for clarifying the procedure. The first example presents vector handling for adding two vectors and the second supports multiplying a tensor by a scalar. PV denotes the defined vector data type, where VPART is the vector structure constructor variable. PT denotes the defined tensor data type, where TPART is the tensor structure constructor variable. The variable “:” denotes an array assignment where all components are assigned. Mixed data types are not allowed. Explicit data typing is required for all variables. As a preprocessing step, the compiler finds the correct function by (i) identifying the operator, and (ii) checking for module procedures with the same the input data types.

III.1 Adding Vector Data Types

If the compiler detects that two vector data types are added and that the result is a vector data type, then an automatic link is generated those calls the function routine FUNCTION ADD_PV in Module PV_HANDLING. Symbolically this equation looks like

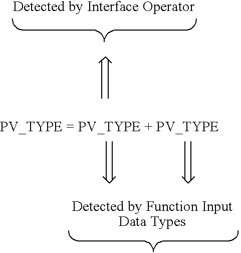

When vector data types are added, an interface operator for addition is defined and a name is assigned for the module procedure that takes two vector data types as input, as presented in the software fragment:

MODULE PV_HANDLING !Vector Operations

.
.
INTEFACE OPERATOR (+)

MODULE PROCEDURE ADD_PV

END INTERFACE
.
.
FUNCTION ADD_PV(A,B)

TYPE(PV) ADD_PV
TYPE(PV), INTENT(IN)::A,B
ADD_PV%VPART(:) = A%VPART(:) + B%VPART(:)

END FUNCTION ADD_PV
.
.

END MODULE PV_HANDLING

III.2 Multiplying a Tensor Data Type by a Real Scalar

If the compiler detects that a real scalar multiplies a tensor data type and that the result is a tensor data type, an automatic link is generated that calls the function routine FUNCTION_R_PT in Module PT_HANDLING. Symbolically this equation looks like

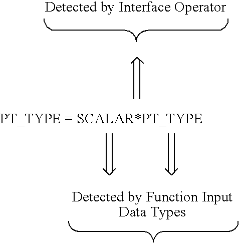

When a real variable and a tensor are multiplied, an interface operator is defined for multiplication and a name is assigned for the module procedure available for multiplying a tensor by a scalar, as presented in the software fragment:

MODULE PT_HANDLING !Tensor Operations

.
.
INTERFACE OPERATOR (*)

MODULE PROCEDURE MULT_R_PT

| END INTERFACE | |
|---|---|
| . | |
| . | |
| FUNCTION MULT_R_PT(R,A) | |
| TYPE(PT) | MULT_R_PT |
| REAL(KIND=8), | INTENT(IN)::R |
| TYPE(PT), | INTENT(IN)::A |

INTEGER::I
DO I = 1,N

MULT_R_PT%TPART(:,I) = R*A%TPART(:,I)

END DO

END FUNCTION MULT_R_PT
.
.
END MODULE PT_HANDLING

The object oriented data typing hides the building of links to the specific subroutines and functions required for completing calculations.

IV. Differential Equation Sensitivity

Linked mechanical systems lead to first-order differential equations of the form:

\dot{x}=M(x)⁻¹f(x,t) (2)

Partial derivatives of Eq. (2) are required for computing state transition matrices and high-dimensional sensitivity operators. Even at second-order the partial derivatives can become quite involved. Using OCEA versions of x, f, and M, one obtains

\dot{x}:=[M⁻¹f, \vec{∇}(M⁻¹f), \vec{∇}\vec{∇}(M⁻¹f)]

The value of the implicit solution is that the inverse of M(x) is never formed explicitly or manipulated to generate the partial derivatives. The complexity of the implicit solution is compared with a conventional sensitivity approach.

IV.1 OCEA Gaussian Elimination Approach:

The calculation for Eq. (2) is simplified by redefining the equation as

M(x)\dot{x}=f(x, t) (3)

$$\dot{x} := [ \dot{x} , [ \begin{matrix}{\dot{x}}_{, {x}_{1}} & ⋯ & {\dot{x}}_{, {x}_{n}}\end{matrix} ] , [ \begin{matrix}{\dot{x}}_{, {x}_{1} , {x}_{1}} & {\dot{x}}_{, {x}_{1} , {x}_{2}} & ⋯ & {\dot{x}}_{, {x}_{n} , x {n}_{1}}\end{matrix} ] ]$$

$$f := [ f , [ \begin{matrix}{f}_{, {x}_{1}} & ⋯ & {f}_{, {x}_{n}}\end{matrix} ] , [ \begin{matrix}{f}_{, {x}_{1} , {x}_{1}} & {f}_{, {x}_{1} , {x}_{2}} & ⋯ & {f}_{, {x}_{n} , x {n}_{1}}\end{matrix} ] ] \text{and}$$

$$M := [ M , [ \begin{matrix}{M}_{, {x}_{1}} & ⋯ & {M}_{, {x}_{n}}\end{matrix} ] , [ \begin{matrix}{M}_{, {x}_{1} , {x}_{1}} & {M}_{, {x}_{1} , {x}_{2}} & ⋯ & {M}_{, {x}_{n} , {xn}_{1}}\end{matrix} ] ]$$

Equation (3) is solved by using an OCEA version of Gaussian elimination. The Gaussian elimination algorithm is identical to standard algorithms, except that a single Use EB_Handling Module command is introduced and variables are typed as needed. The generalized intrinsic operators handle all of the details. The resulting calculation builds the partial derivatives of the state differential equation, without having to form M-1 or any matrix products. A numerical example is given in Section VI.

IV.2 Conventional Second Order Calculation:

Analytically computing the second-order partial derivatives of Eq. (3) leads to

\dot{x}_{,p,q}=(M⁻¹)_{,p,q}f+(M⁻¹)_{,p}f_{,q}+(M⁻¹)_{,q}f_{,p}+M⁻¹f_{,p,q}

where

(M⁻¹)_{,p}=−M⁻¹M_{,p}M⁻¹

and

(M⁻¹)_{,p,q}=M⁻¹M_{,p}M⁻¹M_{,q}M⁻¹+M⁻¹M_{,q}M⁻¹M_{,p}M⁻¹−M⁻¹M_{,p,q}M⁻¹ (4)

By counting the operations for the second-order inverse matrix partials, one finds that (5n²+1 ln)/2 nxn matrix products must be formed (fully accounting for symmetry). Consequently, for a medium-sized system where n=100, one must evaluate 25,550 100×100 matrix products. Comparing Eqs. (2) and (4), one observes that the OCEA solution generates the right-hand-side of Eq. (4) without ever explicitly forming any of the complicated matrix products presented above.

IV.3 State and Parameter Transition Matrix Calculations

The state and parameter transition matrix calculations are presented in this section. Both analytical and OCEA models are presented for generating the partial derivatives. Because the transition matrix variables are implicitly defined, OCEA is used to generate the information required for building the math models for integrating the partials. For simplicity, only a first order version of OCEA is assumed for the derivations presented in Sections IV.3.1 through IV.3.3.

IV 3.1 Analytic State Transition Matrix: The state transition matrix is obtained by integrating a first order model of the form

\dot{x}=F(x,t), xₒ=x|ₜ₌ₜ_{₀} (5)

where x is the nx1 state vector and the sensitivity of the terminal state with respect to the initial state is required. Analytically the required partial derivatives are obtained by integrating Eq. (5) as:

$$x ( t ) = x ( {t}_{0} ) + {\int }_{{t}_{0}}^{t} F ( x ( τ ) , τ ) ⅆ τ$$

and computing the partial derivative with respect to x(t₀), leading to:

$$\frac{\partial x ( t )}{\partial x ( {t}_{0} )} = I + {\int }_{{t}_{0}}^{t} \frac{\partial f}{\partial x ( t )} \frac{\partial x ( τ )}{\partial x ( {t}_{0} )} ⅆ τ$$

where the initial condition is defined by an n×n identity matrix. The governing differential equation for the state transition matrix is obtained by differentiating the equation above with respect to t, yielding the n×n matrix differential equation:

$$\frac{ⅆ}{ⅆ t} ( \frac{\partial x ( t )}{\partial x ( {t}_{0} )} ) = \frac{\partial F}{\partial x ( t )} \frac{\partial x ( t )}{\partial x ( {t}_{0} )} ; \frac{\partial x ( t )}{\partial x ( {t}_{0} )} {\vert}_{{t}_{0}} = I \qquad ( 6 )$$

IV 3.2 Analytic Parameter State Transition Matrix: The parameter transition matrix is obtained by integrating a first order model of the form

\dot{x}=F(x, t; p), xₒ=x|ₜ₌ₜ_{₀}=, p is a (m×1) vector of parameters (7)

where x is the nx1 state vector and the sensitivity of the terminal state with respect to the problem parameters is required. Analytically the required partial derivatives are obtained by integrating Eq. (7) as:

$$x ( t ) = x ( {t}_{0} ) + {\int }_{{t}_{0}}^{t} F ( x ( τ ) , τ ; p ) ⅆ τ$$

and computing the partial derivative with respect to p, leading to:

$$\frac{\partial x}{\partial p} = {\int }_{{t}_{0}}^{t} ( \frac{\partial F}{\partial x ( τ )} \frac{\partial x ( τ )}{\partial p} + \frac{\partial F}{\partial p} ) ⅆ τ$$

where the initial condition is defined by an n×m zero matrix. The governing differential equation for the parameter transition matrix is obtained by differentiating the equation above with respect to t, yielding the n×m matrix differential equation:

$$\frac{ⅆ}{ⅆ t} ( \frac{\partial x}{\partial p} ) = \frac{\partial F}{\partial x ( τ )} \frac{\partial x ( τ )}{\partial p} + \frac{\partial F}{\partial p} ; \frac{\partial x}{\partial p} {\vert}_{{t}_{0}} = 0 \qquad ( 8 ) `$$

IV 3.3 OCEA State and Parameter Transition Matrix Calculations: The state transition matrix differential equation of Eq. (6) is obtained from an OCEA version of Eq. (5), as follows:

$$\dot{x} = F$$

$$\dot{x} := [ \begin{matrix}\dot{x} & \vec{∇} \dot{x}\end{matrix} ] = [ \begin{matrix}{\dot{x}}_{1} & {\dot{x}}_{2}\end{matrix} ]$$

$$F := [ \begin{matrix}F & \vec{∇} F\end{matrix} ] = [ \begin{matrix}{F}_{1} & {F}_{2}\end{matrix} ]$$

where the subscripts denote the different parts of the OCEA variable. By defining the partial derivative variable ∂x/∂x₀, the required differential equations are given by

$$\begin{matrix}{\dot{x}}_{1} = {F}_{1} ; & {x}_{1} {\vert}_{{t}_{0}} = {x}_{0} \\ \frac{ⅆ}{ⅆ t} \frac{\partial x}{\partial {x}_{0}} = {F}_{2} \frac{\partial x}{\partial {x}_{0}} ; & \frac{\partial x}{\partial {x}_{0}} {\vert}_{{t}_{0}} = {I}_{nxn}\end{matrix} \qquad ( 9 )$$

The parameter transition matrix differential equation of Eq. (8) is obtained from an OCEA version of Eq. (7), as follows:

$$\dot{x} = F$$

$$\dot{x} := [ \begin{matrix}\dot{x} & \vec{∇} \dot{x}\end{matrix} ] = [ \begin{matrix}\dot{x} & {\vec{∇}}_{x} \dot{x} & {\vec{∇}}_{p} \dot{x}\end{matrix} ] = [ \begin{matrix}{\dot{x}}_{1} & {\dot{x}}_{2} & {\dot{x}}_{3}\end{matrix} ]$$

$$F := [ \begin{matrix}F & \vec{∇} F\end{matrix} ] = [ \begin{matrix}F & {\vec{∇}}_{x} F & {\vec{∇}}_{p} F\end{matrix} ] = [ \begin{matrix}{F}_{1} & {F}_{2} & {F}_{3}\end{matrix} ]$$

where OCEA variables now include both x and p—which allows the gradient operator to be split into state and parameter parts, where the subscripts denote the different parts of the OCEA variable. By defining the partial derivative variable ∂x/∂p, the required differential equations are given by

$$\begin{matrix}{\dot{x}}_{1} = {F}_{1} ; & {x}_{1} {\vert}_{{t}_{0}} = {x}_{0} \\ \frac{ⅆ}{ⅆ t} \frac{\partial x}{\partial p} = {F}_{2} \frac{\partial x}{\partial p} + {F}_{3} ; & \frac{\partial x}{\partial p} {\vert}_{{t}_{0}} = {0}_{nxn}\end{matrix} \qquad ( 10 )$$

For both Eqs. (9) and (10) OCEA builds the complex and tedious part of the calculation automatically.

V. Simple example problem:

To highlight the required embedded calculations, the following simplified 3D example application is presented. The goal is to compute an embedded version of the composite function y\sqrt{xz}, where the embedded versions of x, y, and z follow as

$$( \begin{matrix}x \\ y \\ z\end{matrix} ) := ( \begin{matrix}[ x , [ 1 , 0 , 0 ] , [ \begin{matrix}0 & 0 & 0 \\ 0 & 0 & 0 \\ 0 & 0 & 0\end{matrix} ] ] \\ [ y , [ 0 , 1 , 0 ] , [ \begin{matrix}0 & 0 & 0 \\ 0 & 0 & 0 \\ 0 & 0 & 0\end{matrix} ] ] \\ [ z , [ 0 , 0 , 1 ] , [ \begin{matrix}0 & 0 & 0 \\ 0 & 0 & 0 \\ 0 & 0 & 0\end{matrix} ] ]\end{matrix} )$$

The following three steps are required:

Step 1: Form the product x*z (using the product operator):

$$\begin{matrix}x * z := [ x [ \begin{matrix}\begin{matrix}1 \\ 0\end{matrix} \\ 0\end{matrix} ] , [ \begin{matrix}0 & 0 & 0 \\ 0 & 0 & 0 \\ 0 & 0 & 0\end{matrix} ] ] * [ z , [ \begin{matrix}\begin{matrix}0 \\ 0\end{matrix} \\ 1\end{matrix} ] , [ \begin{matrix}0 & 0 & 0 \\ 0 & 0 & 0 \\ 0 & 0 & 0\end{matrix} ] ] \\ = [ \begin{matrix}x * z , x * [ \begin{matrix}\begin{matrix}0 \\ 0\end{matrix} \\ 1\end{matrix} ] + z * [ \begin{matrix}\begin{matrix}1 \\ 0\end{matrix} \\ 0\end{matrix} ] , \\ x * [ \begin{matrix}0 & 0 & 0 \\ 0 & 0 & 0 \\ 0 & 0 & 0\end{matrix} ] + [ \begin{matrix}\begin{matrix}1 \\ 0\end{matrix} \\ 0\end{matrix} ] * {[ \begin{matrix}\begin{matrix}0 \\ 0\end{matrix} \\ 1\end{matrix} ]}^{T} + [ \begin{matrix}\begin{matrix}0 \\ 0\end{matrix} \\ 1\end{matrix} ] * {[ \begin{matrix}\begin{matrix}1 \\ 0\end{matrix} \\ 0\end{matrix} ]}^{T} + z * [ \begin{matrix}0 & 0 & 0 \\ 0 & 0 & 0 \\ 0 & 0 & 0\end{matrix} ]\end{matrix} ] \\ = [ x * z , [ \begin{matrix}\begin{matrix}z \\ 0\end{matrix} \\ x\end{matrix} ] , [ \begin{matrix}0 & 0 & 1 \\ 0 & 0 & 0 \\ 1 & 0 & 0\end{matrix} ] ]\end{matrix}$$

Step 2: Compute the \sqrt{x*z} (using the composite function operator):

$$\begin{matrix}\sqrt{x * z} := [ \sqrt{x * z} , \frac{1}{2 * \sqrt{x * z}} [ \begin{matrix}z \\ 0 \\ x\end{matrix} ] , \frac{- 1}{4 * {( x * z )}^{3 / 2}} [ \begin{matrix}z \\ 0 \\ x\end{matrix} ] * {[ \begin{matrix}z \\ 0 \\ x\end{matrix} ]}^{T} + \\ \frac{1}{2 * \sqrt{x * z}} [ \begin{matrix}0 & 0 & 1 \\ 0 & 0 & 0 \\ 1 & 0 & 0\end{matrix} ] ] \\ = [ \sqrt{x * z} , [ \begin{matrix}\frac{z}{2 * \sqrt{x * z}} \\ 0 \\ \frac{x}{2 * \sqrt{x * z}}\end{matrix} ] , \\ [ \begin{matrix}\frac{- {z}^{2}}{4 * {( x * z )}^{3 / 2}} & 0 & \frac{1}{2 * \sqrt{x * z}} - \frac{x * z}{4 * {( x * z )}^{3 / 2}} \\ 0 & 0 & 0 \\ \frac{1}{2 * \sqrt{x * z}} - \frac{x * z}{4 * {( x * z )}^{3 / 2}} & 0 & \frac{- {x}^{2}}{4 * {( x * z )}^{3 / 2}}\end{matrix} ] ]\end{matrix}$$

Step 3: Compute the product y*\sqrt{x*z} (using the product operator):

$$y * \sqrt{x * z} := [ \begin{matrix}y * \sqrt{x * z} , [ \begin{matrix}\begin{matrix}\frac{y * z}{2 * \sqrt{x * z}} \\ \sqrt{x * z}\end{matrix} \\ \frac{x * y}{2 * \sqrt{x * z}}\end{matrix} ] , \\ [ \begin{matrix}\frac{- y * z}{4 * x * \sqrt{x * z}} & \frac{z}{2 * \sqrt{x * z}} & \frac{y * \sqrt{x * z}}{4 * x * z} \\ \frac{z}{2 * \sqrt{x * z}} & 0 & \frac{x}{2 * \sqrt{x * z}} \\ \frac{y * \sqrt{x * z}}{4 * x * z} & \frac{x}{2 * \sqrt{x * z}} & \frac{- x * y}{4 * z * \sqrt{x * z}}\end{matrix} ]\end{matrix} ]$$

The calculations can become extremely complex; nevertheless, the user is completely hidden from the details of the calculations and the calculations are accurate to the working precision of the machine.

VI. Complex Applications

Three classes of applications have been tested using a Fortran 90 version of OCEA. The three application classes consist of: (1) Non-linear n-dimensional vector Jacobian and Hessian calculations. (2) Generation of Lagrange's equations of motion, and (3) Generation of state transition matrix partials. These examples are presented in Section VI. 1 through VI.3.

VI.1 Nonlinear Function Evaluation

A highly nonlinear 7×1 vector algebraic function, F(ξ), of five independent variables, ξ, is considered where F(ξ) is given by:

$$F ( ξ ) = ( \begin{matrix}{e}^{u} + {x}^{2} * cos ( z ) \\ x * u * {( y * z )}^{2} \\ x * y * {z}^{2} \\ {z}^{3} / u \\ z * \sqrt{w} \\ x * u * {sin}^{- 1} ( y / ( u * w ) ) \\ {z}^{1 / 3} * ln ( \sqrt{u} )\end{matrix} )$$

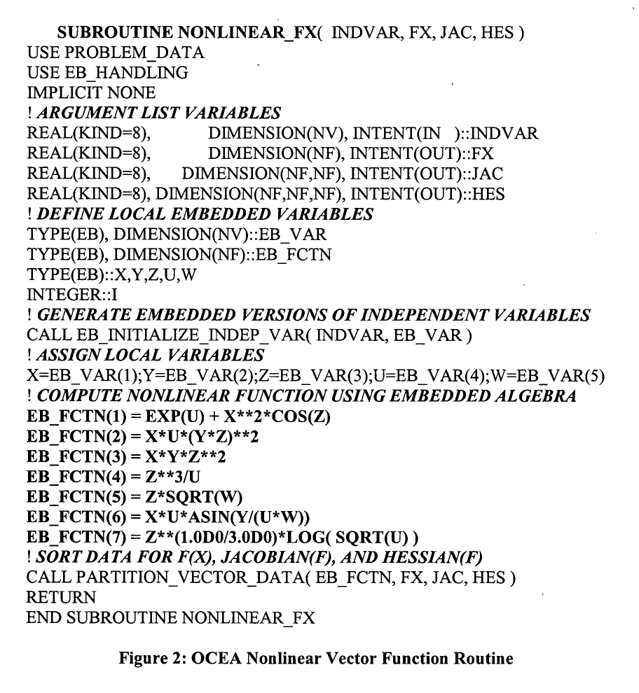

and ξ=(x, y, z, u, w). The computational procedure is outlined in FIG. 2, which consists of a Fortran 90 subroutine for executing the OCEA calculations for the function defined above. The user inputs a real-valued vector of independent variable (i.e., INDVAR). These variables are internally transformed to OCEA variables for the calculation (i.e., EB_VAR). NV denotes the number of independent variables and NF denotes the number of function dimensions to be evaluated, where both are defined in Module Problem_Data. The Module EB_Handling provides all of the OCEA operator overloading and extended function capabilities. The outputs for the routine are: FX-the vector function (7×1), JAC-the Jacobian (7×5), and HES-the Hessian (5×5×7). Numerical results from the subroutine below have been compared with symbolically generated models for the same system using the Macsyma computer algebra system; no errors have been found. For this class of problems the user inputs data in the normal way, writes a math model for evaluating the function, and receives the function, Jacobian, and Hessian without knowing any details about how the calculation is carried out.

VI.2 Lagrange's Equations of Motion

Lagrange's methods is a classical analytical dynamics method that requires the use of first and second order partial derivatives for the building the equations of motion for linked subsystems. A simplified analysis is presented because no rotating frame derivatives are considered. If m-generalized coordinates are available for analyzing the motions of the physical system, the velocity coordinates follow as:

[symbol]

ᵢ= [symbol] ᵢ(q,\dot{q},t); i=1, . . . , n

where q denotes the m1 vector of generalized coordinates and \dot{q} denotes the time derivative of q. The velocity vector is used in building the kinetic energy, leading to:

T=T(q,\dot{q})

The calculations for Lagrange's equations are simplified by defining q and \dot{q} as OCEA variables, and using these variables to evaluate the velocity and kinetic energy. The OCEA version of the kinetic energy becomes:

$$T := [ T , [ \begin{matrix}{T}_{, q} \\ {T}_{, \dot{q}}\end{matrix} ] , [ \begin{matrix}{T}_{, q , q} & {T}_{, q , \dot{q}} \\ {T}_{, q , \dot{q}} & {T}_{, \dot{q} , \dot{q}}\end{matrix} ] ] \qquad ( 11 )$$

which is immediately useful for evaluating Lagrange's in the form:

(T,_{\dot{q},\dot{q}})·\ddot{q}=Q+T_{,q}−(T_{,q,\dot{q}})·\dot{q}

where the generalized force is given by

$${Q}_{q} = {\sum }_{i = 1}^{{N}_{b}} {F}_{i}^{T} {v}_{i , q}$$

and the velocity partial derivative is obtained from the OCEA version of the velocity. This OCEA-based application produces an enormous reduction in the normal labor required for generating Lagrange's equations. Similar labor reductions appear for Hamilton's method. A 2D example is presented in the next section.

VI.2.1 2D Example

Assume that a cart of mass ml rolls without friction on a smooth surface. A linear spring restricts the cart motion in the x-axis direction. A massless rod of length 1 is attached to the cart and has a tip mass m₂. The rod freely rotates about the attachment point to the cart. Gravity is the only assumed external force. The OCEA variables for the problem, are (x, θ, \dot{x}, \dot{θ}). The particle position vectors are given by:

r₁=(x, 0)

r₂=(x+l*cos(θ), −l*sin(θ))

and the velocity variables are given by

v₁=(\dot{x}, 0)

v₂=(\dot{x}−l*sin(θ)*\dot{θ}, −l*cos(θ)*\dot{θ})

To compute the kinetic energy the velocity variables are transformed to OCEA form, where the individual velocity components are given by

$$\begin{matrix}\begin{matrix}{v}_{1 x} := [ \dot{x} , [ \begin{matrix}0 \\ 0 \\ 1 \\ 0\end{matrix} ] , [ \begin{matrix}0 & 0 & 0 & 0 \\ 0 & 0 & 0 & 0 \\ 0 & 0 & 0 & 0 \\ 0 & 0 & 0 & 0\end{matrix} ] ] \\ {v}_{1 y} := [ 0 , [ \begin{matrix}0 \\ 0 \\ 0 \\ 0\end{matrix} ] , [ \begin{matrix}0 & 0 & 0 & 0 \\ 0 & 0 & 0 & 0 \\ 0 & 0 & 0 & 0 \\ 0 & 0 & 0 & 0\end{matrix} ] ] \\ {v}_{2 x} := [ \dot{x} - l * sin ( θ ) * \dot{θ} , [ \begin{matrix}0 \\ - l * cos ( θ ) * \dot{θ} \\ 1 \\ - l * sin ( θ )\end{matrix} ] , [ \begin{matrix}0 & 0 & 0 & 0 \\ 0 & l * sin ( θ ) * \dot{θ} & 0 & - l * cos ( θ ) \\ 0 & 0 & 0 & 0 \\ 0 & - l * cos ( θ ) & 0 & 0\end{matrix} ] ]\end{matrix} \\ {v}_{2 y} := [ - l * cos ( θ ) * \dot{θ} , [ \begin{matrix}0 \\ l * sin ( θ ) * \dot{θ} \\ 0 \\ - l * cos ( θ )\end{matrix} ] , [ \begin{matrix}0 & 0 & 0 & 0 \\ 0 & l * cos ( θ ) * \dot{θ} & 0 & l * sin ( θ ) \\ 0 & 0 & 0 & 0 \\ 0 & l * sin ( θ ) & 0 & 0\end{matrix} ] ]\end{matrix}$$

The kinetic energy for this simple system is given by

T=m₁(v₁ₓv₁ₓ+v_{1y}v_{1y})/2+m₂(v₂ₓv₂ₓ+v_{2y}v_{2y})/2

Using OCEA algebra leads to

$$T := [ \begin{matrix}( {m}_{1} + {m}_{2} ) {\dot{x}}^{2} / 2 - {lm}_{2} sin ( θ ) \dot{x} \dot{θ} + {l}^{2} {m}_{2} {\dot{θ}}^{2} / 2 , \\ [ \begin{matrix}- {lm}_{2} cos ( θ ) \dot{x} \dot{θ} \\ ( {m}_{2} + {m}_{1} ) \dot{x} - {lm}_{2} sin ( θ ) \dot{θ} \\ {l}^{2} {m}_{2} \dot{θ} - {lm}_{2} sin ( θ ) \dot{x}\end{matrix} ] , \\ [ \begin{matrix}0 & 0 & 0 & 0 \\ 0 & {lm}_{2} sin ( θ ) \dot{x} \dot{ θ} & - {lm}_{2} cos ( θ ) \dot{x} \dot{θ} & - {lm}_{2} cos ( θ ) \dot{x} \\ 0 & - {lm}_{2} cos ( θ ) \dot{θ} & {m}_{2} + {m}_{1} & - {lm}_{2} sin ( θ ) \\ 0 & - {lm}_{2} cos ( θ ) \dot{x} & - {lm}_{2} sin ( θ ) & {l}^{2} {m}_{2}\end{matrix} ]\end{matrix} ]$$

where the vector and matrix partitions are easily obtained. In a real engineering application, the elements of T are numbers that are immediately used for evaluating the dynamic response.

VI.3 Equation of Motion Sensitivity.

Given the first-order differential equation of the form

M(x)\dot{x}=f

where the 3×3 matrix M(x) is given by

$$M ( x ) = [ \begin{matrix}{100}_{{x}_{1}} & 5 sin ( {x}_{1} {x}_{2} ) & 50 {x}_{2} {x}_{3} \\ & 50 {x}_{2}^{2} & {x}_{3}^{2} \\ SYM . & & {x}_{1} {x}_{2} {x}_{3}\end{matrix} ]$$

and the 3×1 vector f(x) is given by

$$f ( x ) = ( \begin{matrix}exp ( - {x}_{2} / 2 ) sin ( {x}_{3} ) \\ - 10 \sqrt{{x}_{1} / {x}_{3}} \\ - 10 cos ( {x}_{3}^{2} )\end{matrix} )$$

These equations are evaluated using OCEA algebra and the linear matrix equation is solved by Gaussian elimination. The results have been compared with the Macsyma computer algebra system and all first and second order partial derivatives have been correctly evaluated. Because of the limitations of space, only representative results are presented. Assume that (x₁, x₂, x₃)=(1, 2, 3) as numerical values. The rate vector becomes

$$\dot{x} = ( \begin{matrix}- 0.34422 E - 02 \\ - 0.28868 E - 01 \\ 0.17580 E - 02\end{matrix} )$$

The partial derivative of the rate vector with respect to x₂ follows as

$$\frac{\partial \dot{x}}{\partial {x}_{2}} = ( \begin{matrix}0.87449 E - 03 \\ 0.28898 E - 01 \\ - 0.189552 E - 02\end{matrix} )$$

and the partial derivative of the rate vector with respect to x₂ and X₃ follows as

$$\frac{{\partial }^{2} \dot{x}}{\partial {x}_{2} \partial {x}_{3}} = ( \begin{matrix}- 0.36666 E - 02 \\ - 0.47731 E - 02 \\ 0.43682 E - 02\end{matrix} )$$

These results are typical. All of the first and second order partials have been validated by analytically inverting M(x), multiplying the result by f(x), and explicitly evaluating the partial derivative.

VII Applications

OCEA provides a rational process for generating sensitivity models by creating a new level of scientific and engineering software data abstraction and language extension. It has broad potential use for impacting the design and use of mathematical programming tools for applications in science and engineering. OCEA software replaces a time-consuming, error-prone, labor-intensive, and costly endeavor, with an automated tool that generates exact arbitrarily complex partial derivatives models. By developing the intrinsic operations at the scalar elemental level, the algorithm easily extends to Matrix applications. Future generalization will consider large-scale sparse applications.

### BIBLIOGRAPHY (THIS LIST OF PUBLICATIONS ARE NOT ADMITTED TO BE PRIOR ART)

1 James Turner, “Object Oriented Coordinate Embedding Algorithm For Automatically Generating the Jacobian and Hessian Partial Derivatives of Nonlinear Vector Function,” Invention Disclosure, University of Iowa, May 2002.

2. Andreas Griewank. “On Automatic Differentiation” in Mathematical Programming: Recent Developments and Applications, edited by M. Iri and K. Tanabe, pgs. 83-108, Kluwer Academic Publishers, Amsterdam, 1989.

3. Christian Bischof, Alan Carle, George Corliss, Andreas Griewank, and Paul Hovland, “ADIFOR: Generating Derivative Codes from Fortan Programs,” Scientific Programming, 1:11-29, 1992.

4. Cristian Bishchof, Alan Carle, Peyvand Khademi, Andrew Mauer, and Paul Hovland. “ADIFOR 2.0 User's Guide (Revision CO, “Technical Report ANL/MCS-TM-192, Mathematics and computer Science Division, Argonne National Laboratory, Argonne, Ill., 1995.

5. Peter Eberhard and Christian Bischof. “Automatic Differentiation of Numerical Integration Algorithms,” Technical Report ANL/MCS-P621-1196, Mathematics and Computer Science Division, Argonne National Laboratory, Argonne, Ill., 1996.

6. Paul Hovland and Michael Heath.”Adaptive SOR: A Case Study in Automatic Differentiation of Algorithm Parameters, “Technical report ANL/MCS-P673-0797, Mathematics and Computer Science Division, Argonne National Laboratory, Argonne, Ill. 1997.

7. J. D. Pryce and J. K. Reid. ADOI, a Fortran 90 code for automatic differentiation. Report RAL-TR-1998-057, Rutherford Appleton Laboratory, UK, 1998.

1. A method comprising modeling a physical system to create a computer model of the physical system and determining sensitivity partial derivatives for the model using an object-oriented Cartesian embedding algorithm.

2. A system comprising a computing system storing a computer model of a physical system wherein the computing system includes a computer program executing on the system that determines sensitivity partial derivatives for the model using an object-oriented Cartesian embedding algorithm.

3. An article of manufacture, comprising a computer program stored on a machine readable medium, wherein when executed on a suitable computing system the program determines sensitivity partial derivatives for a model of a physical system, wherein the partial derivatives are determined using an object-oriented Cartesian embedding algorithm.
